(19) United States
(12) Patent Application Publication
(10) Pub. No.: US 2003/0054075 A1
(43) Pub. Date: Mar. 20, 2003

(54) Processing wrap containing colorant

(76) Inventors: Ann Dinh-Sybeldon, Woodridge, IL (US); Howard D. Mogil, River Forest, IL (US)

Correspondence Address: Viskase Corporation, Patent and Trademark Department, 625 Willowbrook Centre Parkway, Willowbrook, IL, 60527, US

(21) Appl. No.: 10/090,833

(22) Filed: Mar. 6, 2002

Related U.S. Application Data
(60) Provisional application No. 60/281,955, filed on Apr. 9, 2001.

(51) Int. Cl. A23G 1/00

(52) U.S. Cl. 426/132

(57) ABSTRACT

This invention relates to the replacement of collagen or cellulose casings and food wrappings with a porous, permeable, absorbent paper or cellophane containing peeling aid and optionally liquid smoke or another food colorant or flavorant in order to deliver color and/or flavor to the encased food.

This application claims the benefit of U.S. Provisional Application Ser. No. 60/281,955 filed on Apr. 9, 2001.

### FIELD OF THE INVENTION

This invention relates to the replacement of collagen or cellulose casings and food wrappings with a porous, permeable, absorbent paper or cellophane containing peeling aid and optionally liquid smoke or another food colorant or flavorant.

### BACKGROUND OF THE INVENTION

Many processed meats, whole muscle meats, cheeses and/or soybean products are produced by either stuffing a shirred, tubular stick of cellulosic or polymeric casing with the product, or by encasing the product, such as whole muscle meats, with a wrapping, such as a collagen based wrap. A netting may then be used to secure the wrapping around the irregularly shaped meat. The encased products are then thermally processed under conditions needed to manufacture the product. Surface appearance, particularly color, and flavor are important in the commercial and consumer acceptance of processed food products such as meats, cheeses, and soybean products. One step that may occur during processing is the contacting of the encased or wrapped product by drenching or spraying it with liquid smoke, which is transported through the casing or wrap, in order to impart characteristic smoke flavor and color to the products. Once the product is fully processed, casings or wrappings may be stripped from the finished product, or if the products have been wrapped with collagen wraps, the collagen wrapping has become an intrinsic part of the processed product, and remains on it.

Various patents disclose coloring or flavor compositions used in food processing, including compositions that contain various natural colorants and liquid smoke.

U.S. Pat. No. 5,955,126 discloses the use of a bixin colorant composition wherein the bixin is contained in a water-soluble film-forming agent, and is applied as an internal colorant on shirred casings, providing a red color to sausages processed inside these casings.

U.S. Pat. No. 4,285,981 (Todd, Jr. et al.) issued in 1981, discloses liquid seasoning compositions useful for flavoring or coloring foods and beverages. The disclosed compositions are purportedly dispersible in both oil and water, and consist essentially of lecithin, tartaric acid esters of mono- and di-glycerides, and one or more edible flavorants or colorants such as annatto extract, bixin or norbixin.

U.S. Pat. No. 4,699,664 (Hettiarachchy et al.) issued in 1987, discloses a process for preparation of natural pigment complexes having improved stability against oxygen, heat, light and moisture, and which are water soluble under acidic conditions. In the disclosed process, a pigment such as bixin, norbixin or betanin is combined with at least one inorganic polyvalent cation source and with at least one hydrocolloid having at least one carboxyl group in an aqueous alkaline medium. Compositions are also claimed in which a polyvalent cation is associated with both the pigment and the hydrocolloid through their respective carboxyl groups.

U.S. Pat. No. 4,877,626 (Ande et al.), which issued in 1989, discloses that a mixture of liquid smoke, caramel and optionally bixin (or annatto) may be used to directly color raw meat prior to processing.

U.S. Pat. No. 4,759,936 (Best et al.), which issued in 1988, discloses a food coloring composition that may comprise annatto, an oil (preferably of triglycerides), an emulsifier (preferably of monoglycerides, diglycerides or mixtures thereof), and a gelling agent of carrageen and water.

U.S. Pat. No. 5,079,016 (Todd, Jr.), which issued on Jan. 7, 1992, discloses color stabilized carotenoid pigment compositions that consist essentially of an annatto, tomato, carrot, marigold, or synthetic carotenoid in combination with a nonionic surfactant.

U.S. Pat. No. 5,139,800 (Anderson et al.), which issued Aug. 18, 1992, discloses a composition comprising a dispersed phase consisting essentially of a colorant (or a colorant dissolved or dispersed in an oil-immiscible medium) and a continuous phase consisting essentially of an oil or edible fat, wherein the composition is colorless when applied to food, but causes browning upon cooking. The colorant may comprise water-soluble annatto, beet powder, carmine or caramel among others. The composition is disclosed as being suitable for application to foodstuffs including poultry, beef, fish, cheese, pork, fruits and vegetables.

Self-coloring food casings are also used in the processed food industry, and are generally thin-walled tubing of various diameters, typically prepared from cellulose. In general, these food casings are stuffed with sausage meats, which are then processed. During the processing, color is transferred to the encased foodstuff, thereby coloring the surface of the finished product. Typically the encased foodstuff is sausage made from beef, pork, chicken, turkey or other meats. In the sausage meat industry, the casing from around the processed meat is removed prior to final packaging. These skinless sausages are generally processed in nonfiber-reinforced (nonfibrous) cellulose casing. The term “nonfibrous” is used here to mean without use of fiber reinforcement (e.g., a paper tube) in the casing and nonfibrous is most commonly understood in the art to refer to casings without paper or a previously bonded fiber reinforcement. Nonfibrous casings are typically used to process small diameter sausages including polish sausages, wieners, or frankfurters. However, larger diameter sausages such as salami are frequently sold with the casing left on. These sausages are usually packaged in fiber-reinforced (fibrous) cellulosic casing or nylon casing. Self-coloring casing transfers colorant to the sausage surface during processing so that the sausage surface remains colored after removal of the casing.

Another type of casing is collagen. Collagen is typically isolated from natural sources, such as bovine hide, cartilage, or bones. Bones are usually dried, defatted, crushed, and demineralized to extract collagen, while hide and cartilage are usually minced and digested with proteolytic enzymes other than collagenase.

Collagen may be denatured by boiling, thereby producing gelatin.

Collagen sausage casings are well know in the art, and such casing and various methods for their manufacture have been described in various patents, including U.S. Pat. No. 3,123,653, which taught the production of exceedingly thin-walled collagen casings from a fluid extrusion mass of acid-swollen collagen fibrils, by extruding the fluid mass in a tubular form into a concentrated solution of ammonium sulfate that coagulates and hardens the tubular body, which is then washed, tanned and plasticized in liquid baths and dried while inflated under pressure. U.S. Pat. No. 3,535,125 improved that process by teaching a totally dry process. U.S. Pat. No. 3,664,844 teaches edible collagen films made by extrusion of an acid-swollen collagen extrusion mass containing collagen treated with a fungal protease, water and plasticizer.

Self-coloring cellulosic casings are disclosed in U.S. Pat. Nos. 2,477,767; 2,477,768; and 2,521,101. These casings are designed to transfer color to the sausage surface. Such casings are generally either coated or impregnated with food grade water-soluble dyes and have also been made commercially available with nontransferable black or white or colored opaque stripes. Also, liquid smoke impregnated casings are known to transfer liquid smoke to the surface of sausages encased therein, transferring a flavorant or colorant and also causing a browning reaction on the sausage surface.

Liquid smoke solutions are available in a number of formulations. Previously, standard liquid smoke solutions were known as “as-is” solutions, where the liquid smokes were generally highly acidic within a pH range of about 2.0 to about 2.5 and a titratable acidity of at least 3 wt. %, and also contained tar-like components. When used to treat casings, particularly the external surface of a casing, the tar content caused sticky deposits to accumulate on equipment used to treat the casing. The acidity of the liquid smoke also interfered with the peelability of the casing by interfering with the action of the peeling aid used, such as carboxymethyl cellulose. The low pH liquid smoke also caused the cellulose to degrade, resulting in pinholes and such in the casing itself. In addition, iron contamination caused dark spots on the processed sausages, which were then unacceptable to the consumer.

It was found that tar could be removed from the liquid smoke by neutralizing the “as-is” smoke to precipitate the tar, filtering resulting solids, and by adding polysorbate, which solubilized all remaining tars, thereby eliminating the tarry deposit accumulation problem. Further treatment of the casings containing liquid smoke with sodium biphosphate is often used to prevent black spotting on the enclosed foodstuffs caused by the iron contamination. Neutralization of the liquid smoke, even partially, reduces the cellulose degradation problem, and allows the peeling aids to perform as intended, as described in U.S. Pat. No. 4,540,613, which is incorporated herein by reference.

Recently, cellulosic casings have been coated with, in particular, neutralized, concentrated, tar-depleted liquid smoke (see U.S. Pat. Nos. 4,356,218; 4,511,613; and 4,818,551, which are hereby incorporated by reference in their entirety) to provide the basic smoke color. The casings may be treated with phosphates to inhibit discoloration and black spot formation on the casing, as disclosed in the above patents. However, it is well known that an acidic liquid smoke delivers, after cooking under low humidity conditions, a deep reddish-smoky color to the surface of sausages treated with it. It is also well-known in the art that acidic liquid smoke interferes with the water soluble cellulose ethers, such as CMC, that are used as peeling aids, making it very difficult, if not impossible, to mechanically remove the spent casing cleanly, without damaging the sausages encased within, with a high speed peeler. Acidic liquid smoke also causes, in time, cellulose degradation in the casing, thereby weakening it for the sausage manufacturer. For the customer, acidic smokes are hard on equipment and pose environmental pollution issues in some geographical areas. The neutralized liquid smokes are presently the liquid smokes of choice, although some manufacturers still use acidic liquid smokes.

Treating edible collagen casing or films with liquid smoke has also been taught by U.S. Pat. No. 3,894,158, which is herein incorporated in its entirety, where the liquid smoke is introduced into the liquid mass of acid-swollen collagen prior to its extrusion as a tube or film, primarily to strengthen the casing. Since the collagen casing or film remains on the finished product, the color of the liquid smoke is discernible in this product. U.S. Pat. No. 4,446,167 also discloses that a liquid smoke having a pH in excess of 10 and applied to cellulosic or collagen casing will transfer the smoky flavor to the meat product processed in the casing.

U.S. Pat. No. 3,860,728 teaches introducing caramel coloring to collagen sausage casings, to improve the strength and color of the edible casing. It is taught that the collagen and the caramel interreact to form a strongly bound complex from which the caramel is not detached from the collagen when the casing is subject to later cooking.

U.S. Pat. No. 4,504,500 discloses coating a collagen or cellulosic casing with liquid smoke, and the smoky flavor is transferred to the processed meat.

U.S. Pat. No. 4,604,309 teaches the use of neutralized liquid smoke on casings, both cellulosic and those made of collagen, with the resulting smoky color and flavor being transferred to the encased food product.

Non-edible casing or wrapping films may be removed by the food processor prior to sale of the finished product. This is particularly seen with skinless sausages. In the formation of skinless frankfurters, where the casing is removed after processing, sausage proteins coagulate, particularly at the sausage surface, to produce a skin and allow formation of a liquid layer between this formed skin and the casing as described in U.S. Pat. No. 1,631,723 (Freund). Skin formation is known to be produced by various means including the traditional smoke curing with gaseous smoke, low temperature drying, application of acids such as citric acid, acetic acid or acidic liquid smoke or combinations thereof. Desirably, this secondary skin will be smooth and cover the surface of the frankfurter. Formation of a liquid layer between the casing and the frankfurter skin facilitates peeling and relates to the meat emulsion formulation, percent relative humidity during the cooking environment, subsequent showering, and steam application to the chilled frankfurter.

Also, application of certain types of coatings to the inside wall of food casings may afford improvement in the release characteristics of the casing from the encased sausage product. Use of peeling aids or release coatings has helped to overcome peelability problems associated with process variables. Following cooking, cooling and hydrating, peeling aids such as water-soluble cellulose ethers help release the casing from the frankfurter skin by formation of a peeling enhancing layer between the casing and the frankfurter skin.

In U.S. Pat. No. 3,898,348, the coating of internal surfaces of cellulose sausage casings with a homogeneous mixture of a water-soluble cellulose ether peeling aid and a pleat release agent selected from animal, vegetable, mineral and silicon oils and alkylene oxide adducts of partial fatty acid esters was taught. Such mixtures have excellent meat release characteristics and can also effectively protect the casing from “pinholing” failures occasioned by pleat locking. Easy peeling casings utilizing the release coating have found broad commercial acceptance and are presently in use in casings throughout the world.

U.S. Pat. No. 4,137,947 to Bridgeford discloses a method of improving the meat release (peelability) of cellulose sausage casings by the application of a meat release coating to the internal surface thereof prior to shirring. The aqueous coating is an admixture of a water-soluble cellulose ether, the partial fatty acid ester of sorbitan or mannitan and a water-soluble polyalkylene ether. These peeling aid coatings have been used with varying degrees of success to provide cellulosic casings capable of being peeled on high speed machine peelers. Generally such cellulosic casings, either with or without peeling aid coatings, have an approximately neutral pH with pH values typically falling within a range of about 5.9 to 8.6.

When collagen is used, the casing or film remains on the surface of the meat, as the proteins of the collagen interbond with the proteins on the surface of the meat, or other food products. It is not possible to remove a collagen coating after thermal processing.

When products such as whole muscle meats are wrapped in cellulosic sheets and thermally processed, peeling aids are generally needed on the food-contact surface of the sheets. However, such peeling aids may not be needed to remove the sheets when the fat content of the meat is high enough to produce a layer between the sheets or casings and the processed meats that would allow for the easy and complete removal of the wraps.

Sheets made of collagen materials have been generally used in the processing of many food products. Unfortunately, recent events in animal husbandry have produced cattle that are infected with agents causing a disease known as Bovine Spongiform Encephalitis (“BSE”), or colloquially as Mad Cow Disease. Fear of this neurotoxic disease being spread to the human population is prevalent in areas where the BSE contaminated cattle have been found. In addition, outbreaks of Hoof and Mouth Disease have also erupted across Europe, devastating the animal populations and quarantining any products made from diseased animals. Because of these recent developments, there is a concern that collagen-based products may serve as a medium to pass on these diseases to uninfected areas, or to uninfected people.

### SUMMARY OF THE INVENTION

We have discovered that articles made from porous paper or cellophane and impregnated with peeling aids, and optionally with liquid smoke and/or other flavorants or colorants, can replace collagen and cellulose casings and films to produce acceptably flavored and colored food products such as meats, cheeses, or soybeans, which are readily removed from the encased, processed food product. The very high absorbency of these articles enables the absorbency rate to be controlled to a high degree, thus satisfying the flavor and color requirements of a diverse customer base, while eliminating any concerns that may arise due to animal husbandry practices.

The prior art does not teach the use of absorbent papers, particularly non-wovens containing hemp fibers, or cellophane, as a transfer medium for coloring and flavoring agents, nor does it teach the use of such absorbent papers containing peeling aids, for use in processing food products.

In particular, our invention is an article for imparting a smoky color and flavor to a food product processed or packaged in this article, the article being a porous, permeable, absorbent substrate sheet made of paper or cellophane having sufficient suppleness and elasticity to be wrapped around the food product and that the food-contacting surface of the article contains a liquid smoke in an amount of at least about 10% based on the weight of the substrate and also contains a peeling aid to make the article peelable from the processed food product. In addition, this article has sufficient permeability to allow for the transfer of color and flavor to the food product during the processing of the food product encased in the substrate sheet; and has sufficient wet strength, cohesion and peelability to be removed from the processed food product without leaving a substrate residue on the food product.

The invention also includes a process of adding liquid smoke color and flavor to processed food products by encasing them in the above described article and processing them and a process for the manufacture of this article.

### DETAILED DESCRIPTION OF THE INVENTION

We have discovered a novel method for treating food products such as meats, cheeses, and bean-based products, wherein each market segment or customer preference can be accommodated by adding a desired amount of liquid smoke to color and flavor the desired food product by the use of a paper or cellophane impregnated with such compositions. In some cases, a peeling aid, and a liquid smoke may be combined with a coloring agent and/or a flavoring agent, or alternatively, a coloring agent or a flavoring agent alone may be used on the wrapping medium. Usually the ratio of liquid smoke to a coloring or flavoring agent is from about 1:20 to about 20:1, preferably from about 1:10 to about 10:1. The ratios are controlled to meet the specifications of the customers and therefore vary widely. Food products that do not need to have additional colorants or flavorants may be wrapped with the paper or cellophanes of the present invention that are impregnated with a peeling aid solution and used to process the food product.

This advance in the processing of meat products and cheese has been effected by replacing the conventional collagen casings and cellulose casing with a porous permeable paper or cellophane treated with liquid smoke known to be used for imparting smoke color and flavor to meat products and cheese. The porous paper or cellophane has the ability to absorb liquid smoke in amounts greater than 10%, and particularly from about 10 to greater than 1000% based on the weight of the untreated paper or cellophane. Neither collagen nor cellulose casings exhibit this property. This is a critical feature enabling food processors, and in particular meat and cheese processors, to tailor make the flavor and color of their products to the demand of the particular market. Studies have shown that color and flavor preference for meat products and cheeses vary all over the world and therefore the flexibility offered by the treated, porous, absorbent papers and cellophanes of this invention meets an urgent need of the food industry. And as the article is made from paper or cellophane, the possibility of transmitting an animal-based disease agent to humans (or to animals) is nonexistent. In addition to the paper or cellophane, a thin, flexible cloth may also be used in this invention. Such cloth must be made of a material that is able to absorb the liquid smoke composition, or any composition of the present invention, and be flexible enough to wrap around the product to be encased by the treated cloth.

The treated paper exhibits sufficient permeability for the smoke color and flavor to be transferred to the food products. The basis weight of the untreated porous paper is at least 12.3 g/m² as measured by the method found in TAPPI T-410, OM-83. The upper limit is the governed by the economics of the particular situation—papers having very high basis weights would be uneconomical. The usual range is about 25 to 65 g/m². The data in the examples show a range of about 12.3 to 28 g/m². The paper should have a machine direction (“MD”) wet tensile strength of at least 970 g/25 mm stretch, as measured by the Dexter Corporation Method 59-2/88. The usual range is from about 970 to about 1800 g/25 mm stretch. The preferred range is from about 1020 to about 1625 g/25 mm stretch. The cross direction (“CD”) wet tensile strength should be at least 350 g/25 mm stretch, as measured by the same Dexter Corporation Method 59-2/88. A suitable range is 410 to 1300 g/25 mm stretch. The CD dry tensile strength should be at least 900 g/25 mm stretch, as measured by the Dexter Corporation Method 57C-1/82. A suitable range is from about 930 to about 4,750 g/25 mm stretch.

Any commercially available cellophane is useful in our process. Dry cellophane is highly permeable to water vapor with good barriers to flavors and aromas, but when wet it exhibits similar permeability and barrier properties as does cellulosic casing. The cellophane has to be elastic. The MD dry strength should be at least 125 MN/m² stretch and the CD dry strength should be at least 70 Mega Newton (“MN”)/m² stretch, as determined by the standard method of ASTM 0882. There is no maximum for these values. The basis weight of the cellophane should be at least 29 g/m², with the usual range being from about 29 to 60.

A critical feature of our invention is that the treated, absorbent, permeable papers and cellophanes have sufficient suppleness and elasticity to be wrapped around food products. Food products include meats, cheeses, and products produced from beans, such as soy beans. The meats may include whole muscle meats such as hams, beef roasts, chickens and chicken parts, turkeys and turkey parts. Food products also include any food that may be smoked or processed with the use of the inventive article. This suppleness and elasticity of the papers and cellophanes enables the treatment process to be used on irregular product sizes. This is particularly important in the treatment of hams, which vary greatly in size and therefore the suppleness and elasticity of the paper product enables us to serve this market. Other meat products also have irregular shapes, which are hard to treat by conventional casings, but are readily handled with our treated paper products or cellophane.

Our treated paper is designed so that it retains enough cohesion, wet strength and peelability so that it may be easily and completely removed from the processed food product. Generally, a peeling aid must be added to the food-contacting side of the article so that the treated paper can readily be removed from the surface of the food product without leaving a paper residue.

Treated paper may be used without a peeling aid if it has a basis weight of at least 25 g/m² and used with high fat content food products. Without a peeling aid, the paper cannot be readily removed from other types of food products. By high fat content we mean a meat product comprising from about 20 to about 50% fat by weight. All cheese products are considered high fat content products.

The preferred porous, permeable, absorbent paper products are nonwoven and contain hemp fiber. This type of paper in “untreated” form has characteristics similar to the usual tea bag paper. Other papers produced from cellulose alone, or in combination with synthetic fibers and/or hemp fibers, are also acceptable. Such porous paper can suitably be treated with liquid smoke as discussed above. Coloring agents and flavoring agents may be suitably added to the liquid smoke composition or they may totally replace it. Suitable coloring agents include natural colorants and flavorants such as caramel, annatto, and FD&C food grade colors, including red #40 and yellow #6. Suitable flavoring agents may include oleo resins and seasonings such as paprika, pepper and garlic onions. The ratio of coloring agent or flavoring agent or the combination of the two to liquid smoke is from about 1:20 to about 20:1, preferably from about 1:10 to about 10:1. Liquid smoke alone may be completely replaced with a coloring agent, a flavoring agent, or a combination of all three.

For optimum peeling results, a peeling aid is employed. Suitable peeling aids include lecithin, lecithin in an edible hydrocarbon diluent, lecithin in combination with alginates, alginic acid, chitosan, casein, wax, shortening and vegetable oil. Other suitable peeling aids include water soluble cellulose ethers, such as methyl cellulose, carboxymethyl cellulose, ethyl methyl cellulose, hydroxy propyl cellulose, hydroxy ethyl cellulose, hydroxy propylmethyl cellulose, and ethyl hydroxy ethyl cellulose. The water-soluble cellulose ethers can be used in combination with lecithin. In addition, alkylketene dimer may be used as a peeling aid.

It has been discovered that to increase yield and shelf life for processed food products, it is preferred that the side of the treated paper not in contact with the food products is coated with a moisture vapor and/or oxygen impermeable coating or film. Examples of suitable films are films made of polyvinylidene polyvinyl chloride, polyvinyl acetate, polyvinyl alcohol, polyethylene, and mixtures thereof, and saran wrap, which is comprised of polyvinylidene chloride and possibly small amounts of related polymer moieties. Other coatings that are moisture and vapor barriers may also be used. The treated paper and cellophane of this invention is produces in the form of a roll or a sheet.

The liquid smoke, peeling aid, coloring agent, and flavoring agent all are in the pH range of from about 2 to about 14. In a preferred process, the absorbent paper product is treated in a bath containing an emulsion of liquid smoke and peeling aid. The treated paper product is removed and is rolled in rolls or cut into sheets. The absorption of the liquid smoke is controlled to be at least about 10%, and may be greater than 1000%, based on the weight of the untreated paper or untreated cellophane. In a suitable procedure, liquid smoke is absorbed between about 300 and 500% by weight of the paper product. The great variability of the amount of liquid smoke absorbed on the paper or cellophane is a significant advantage for this inventive process since it enables the article to be tailor-made to a customer's requirements. As described above, liquid smoke can be replaced with a coloring agent, a flavoring agent, or any combination of all three.

We have discovered a process for adding liquid smoke color and flavor to processed foods without the use of collagen or cellulose casing. This process comprises covering the surface of the food products with a porous, absorbent paper or cellophane, preferably a non-woven paper and more preferably a paper made of hemp fiber having a basis weight of at least 12.3 g/m². A suitable weight of the paper is from about 25 to about 65 g/m². This paper or cellophane is treated with peeling aids and liquid smoke used to impart color and flavor to processed foods. Coloring and flavoring agents and peeling aids may also be mixed in with the liquid smoke used to treat the paper or cellophane. In some applications, liquid smoke is not employed and either no or other flavoring and/or coloring agents are utilized. Liquid smoke may also be used in combination with either a coloring agent and/or a flavoring agent, as described above. The ratio of the total coloring and/or flavoring agent(s) to the liquid smoke is from about 1:20 to about 20:1, preferably being from about 1:0 to about 10:1. In applications where no coloring or flavoring is desired, only the peeling treatment is employed.

The various compositions containing any combination of liquid smoke, coloring agents, flavoring agents, and peeling aids may be applied to the paper or cellophane substrates in a number of well known ways. One way is to print the compositions on the absorbent paper or cellophane substrates. The printing process can be any one of the well-known processes such as, blade, gravure, and flexo.

Another method of applying any of the various compositions containing any combination of liquid smoke, flavoring agents, coloring agents, and peeling aids to the porous paper or cellophane is by drenching the paper and cellophane substrates in the preferred liquid composition of the present invention. Spraying the substrate with the desired composition is another way of treating or coating it. The length of time needed to spray, soak, or treat the substrate will depend on the type of substrate used and the color and/or flavor intensity, if any, desired in the final processed food product.

The invention is further described in the following examples but it should be noted that the examples are for illustrative papers only and in no way limit the scope of this invention as set forth in the claims.

### EXAMPLE 1

The test article samples consisted of papers supplied by Dexter Corporation, of various weights; of cellophane of various weights, and supplied by UCB; and a control sheet of a collagen product known as “Collagen”, sold by Bechdorin Kollagenfolien GmbH, located in Reichshof Wehnrath, Germany. The test papers and cellophanes are described in Table 1 below.

TABLE 1
PAPERS AND CELLOPHANES

| | | Basis wt. | Thickness | | MD Wet | CD Wet | |
|---|---|---|---|---|---|---|---|
| | | gm/m² | in | CD Dry Tensile, | Tensile, | Tensile | MD Dry |
| Sample | Fiber | (paper) | microns | g/25 mm (paper) | g/25 mm | g/25 mm | MN/m² |
| 1234T | Synthetic, | 16.5 | 92 | 660 | 630 | 180 | — |
| | hemp, | | | | | | |
| | cellulose | | | | | | |
| 11597 | Cellulose, | 21.0 | 100 | 1200 | 820 | 410 | — |
| | synthetic | | | | | | |
| 11697 | Cellulose, | 24.0 | 99 | 1600 | 1020 | 510 | — |
| | synthetic | | | | | | |
| 13285 | Hemp, | 12.3 | 53 | 930 | 1200 | 360 | — |
| | cellulose | | | | | | |
| 13286 | Hemp, | 12.3 | 53 | 900 | 970 | 350 | — |
| | cellulose | | | | | | |
| 15190 | Hemp | 19.0 | 87 | 2950 | 1110 | 890 | — |
| 15220 | Hemp | 22.0 | 96 | 3650 | 1300 | 1040 | — |
| 15237 | Hemp | 23.7 | 102 | 4000 | 1435 | 1150 | — |
| 15254 | Hemp | 25.4 | 107 | 4450 | 1500 | 1200 | — |
| 15280 | Hemp | 28.0 | 117 | 4750 | 1625 | 1300 | — |
| UCB | Cellophane | 29.8 gm | 208 | *70 MN/m² | — | — | 125 |
| 300P | | | | | | | |
| UCB | Cellophane | 57.7 gm | 41.7 | 70 MN/m² | — | — | 825 |
| 600P | | | | | | | |

*MN = Mega Newton

The following composition was used to contact all test papers and cellophanes, except for the control samples. The composition of the solution is as follows:

TABLE 2
TEST COMPOSITION

| Components | Wt. % |
|---|---|
| Liquid smoke¹ | 60.0 |
| D.I water | 18.0 |
| CMC 7LF² | 1.0 |
| Potassium | 0.2 |
| tetrapyrophosphate | |
| Centrolex PD³ | 20.8 |
| TOTAL | 100.0 |

¹Obtained from Red Arrow Products Company, Manitowoc, Wisconsin, USA.
²Carboxymethyl cellulose, from Hercules, Wilmington, Delaware, USA.
³Lecithin from Central Soya Company

The Collagen control was not treated at all and the paper control sample was treated with the test composition that lacked the liquid smoke component. Each of the sample substrates were treated with the composition of Table 2 by dipping them into a bath of the above composition until the test samples were saturated with the composition, about one minute, at room temperature. The saturated sample substrates were then removed from the dipping tank and the excess solution was removed from the substrates by squeezing the treated substrates. The prepared test samples are described in Table 3 below.

TABLE 3
DESCRIPTION OF TEST ARTICLES

| | SIZE | | Wt. % LIQUID |
|---|---|---|---|
| SAMPLE | (inches) | TYPE | SMOKE GAIN |
| Control 1 | 20 × 28 | Collagen sheet | 0 |
| Control 2 | 20 × 28 | 15254 | 0* |
| 1 | 8 × 11 | UCB 300P | ˜300 |
| 2 | 8 × 11 | UCB 600P | ˜300 |
| 3 | 20 × 28 | 15190 | ˜450 |
| 4 | 20 × 28 | 15220 | ˜450 |
| 5 | 20 × 28 | 15237 | ˜450 |
| 6 | 20 × 28 | 15254 | ˜450 |
| 7 | 20 × 28 | 15280 | ˜450 |
| 8 | 20 × 28 | 13286 | ˜450 |
| 9 | 20 × 28 | 11697 | ˜450 |

*This control contained about 300 wt. % of peeling aid.

The ham used in evaluating the treated paper and treated cellophane was a 30% sweet pickled, boneless, inside and outside, sectioned ham that was vacuum tumbled for four hours. Hams were heavily macerated prior to injecting with brine solution. Control and treated sheet samples were placed on a table and the two sections of ham were placed in the center of the sheet. The sheet was folded around the ham sections and was placed inside a Coffi Stuffer horn that was used as a stuffing horn. The Coffi Stuffer horn had either size 6½ or Size 7 Scotnet netting hand shirred on the outside of the hams. The ham wrapped with the control and test articles was pushed through the horn by hand and then a tie clip was applied, using approximately 20 psi pull up force on both sides of the ham, to tightly contain the ham inside the netting. Test hams were thermally processed using the following procedure:

TABLE 4
PROCESSING SCHEDULE

| | | | Dry Bulb | Wet Bulb | Relative |
|---|---|---|---|---|---|
| Step | Step | Step | Temperature | Temperature | Humidity |
| No. | Type | Time (min.) | (F. °) | (F. °) | (%) |
| 1 | Cook | 10 | 160 | 125 | 37 |
| 2 | Liquid | 15/5 | Ambient House Off | | |
| | Smoke | | | | |
| 3 | Cook | 30 | 170 | 130 | 34 |
| 4 | Cook | 360 | 185 | 145 | 37 |
| | (IT = | | | | |
| | 156°) | | | | |
| 6 | Shower | NONE | | | |

Control samples (hams wrapped in papers without liquid smoke treatment) were sprayed with atomized smoke for 15 minutes, and allowed to set for 5 minutes. These control samples were then placed in a smokehouse.

After the thermal processing, the test ham samples were chilled for two days at 35° F. and then were evaluated.

All treated ham samples, including the paper coated control, had no peeling problems, with the exception of the ham wrapped with the paper sample 13286, a tea bag paper. This paper wrap disintegrated when pulled away from the ham surface after processing, leaving behind some fibrous strands on the processed ham. This effect may have been caused because of the weight of the paper substrate.

Observation of the hams showed similar strong smoke flavor on the surface of all test paper and cellophane wrapped hams, including the control ham wrapped with paper and oversmoked. Bite texture on the overlapped regions of the control Collagen film ham surface were tougher and more chewy than on the hams processed with test wraps made of paper substrates, but the paper wrapped hams had a stronger, more acrid smoke flavor than did the Collagen wrapped hams. This more acrid smoke flavor is a result of the overlapping of the paper and the high smoke loading.

### EXAMPLE 2

The treatment of the paper and cellophane substrates with the liquid smoke compositions was similar to that set forth in Example 1. Components of the treating composition was as follows:

TABLE 5

| Components | Wt. % |
|---|---|
| Red Arrow RA99-032 Liquid Smoke | 60.0 |
| Water | 19.0 |
| Slip Ayd 535 EK¹ | 1.0 |
| Tween 80 | 5.0 |
| Mineral Oil | 5.0 |
| TOTAL | 100.0 |

¹Carnauba wax emulsion, made by Elementis Corporation.

Five test samples were run. One untreated collagen control was tested, and two untreated paper controls were tested. Two papers were saturated with the test solution of Table 5, as described in Example 1. The test samples are described in Table 6 below.

TABLE 6
TEST SAMPLES

| | | | Wt. % Liquid |
|---|---|---|---|
| Sample | Type | Width (inches) | Smoke Gain |
| Control 1 | collagen | 22.7 | 0 |
| Control 2 | 15254 | 22 | 0 |
| Control 3 | 15280 | 22 | 0 |
| Sample 1 | 15254 | 22 | 300+ |
| Sample 2 | 15280 | 22 | 300+ |

The boneless hams were prepared, wrapped with the controls and test papers, and the test was run as in described in Example 1. The fully processed hams were then tested for color absorbance using the Hunter L,a,b test.

Hunter L,a,b values are standard color scale values which indicate differences in brightness, hue and saturation using a standard color system that relates lightness as L values, and hue and chroma as a combination of a and b values on a coordinate scale where “a” represents redness-greenness and “b” represents yellowness-blueness. L values describe the degree of darkness, where a value of 100 equals white and that of 0 equals black. “a”-values describe the degree of redness, which increases with an increasing a-value. “b”-values describe the degree of yellowness, which increases with increasing b-value. L,a,b and opacity theory and measurement are further described in the Instruction Manual Hunter Lab 45°/0° D25-PC2ΔColorimeter, pp. 1-1 through index-5. (Hunter Associates Laboratory, Inc., April, 1988). Hunter L,a,b and color scale values and opacity may be measured by the following tests.

Encased or peeled meats may be tested as is. L,a,b values and opacity are measured using a colorimeter such as a Hunter D25-PC2Δ colorimeter available from Hunter Associate Laboratory, Inc. of Reston, Va., U.S.A. or the Color Machine Model 8900 available from Pacific Scientific.

Samples are placed on the sample plane of the colorimeter (which is calibrated using standard tiles according to the manufacturer's instructions) where an angled incident light from a quartz-halogen lamp (clear bulb) illuminates the sample. An optical sensor placed at 0° (perpendicular to the sample plane) measures the reflected light that is filtered to closely approximate CIE 2° Standard Observer for Illuminant C. Values are reported using a standard Hunter L,a,b color scale.

As an example, sausage casing sample placement is accomplished as follows. A tubular casing sample is cut open (opposite the seam if any) in the longitudinal direction to form a film having a single thickness. The casing sample is placed on the white tile provided for measuring samples, taking care to avoid locating any seams or folds in the sampling area. The casing and tile are then held in close contact against the sample port, that is equipped with a sample port insert having an appropriately sized aperture. The aperture should be no larger than the area to be sampled. The casing is placed with the axis of the longitudinal direction (machine direction) perpendicular to the path of the incident light travelling to the sample from the quartz-halogen lamp light source. The cut casing is generally positioned so that the former exterior surface of the tube is adjacent to the sample port. Alignment of the casing sample is checked to avoid dryer folds and obvious defects before L,a,b values are measured. The casing sample is then repositioned to a different area of the casing sample and L,a,b values are measured again (taking care to avoid seams and folds).

Measurements of L,a,b colorimetry values for meat samples are similarly performed except that the meat sample, either encased or peeled, is held directly against the port opening, typically a circular opening about 2 inches in diameter, and it is not necessary to use a tile background during measurement.

The results of the L,a,b test are shown in Table 7.

TABLE 7
Color Evaluation for Liquid Smoke Treated Paper and Cellophane

| | Colorimetric Scores | | | Netting Impression |
|---|---|---|---|---|
| Description | L-Values | a-Values | b-Values | Score |
| Control 1 | 31.1 ± 3.3 | 14.1 ± 1.5 | 10.2 ± 1.9 | 4.5 |
| Control 2 | Could not evaluate due to strong | | | — |
| | paper adherence to meat surface | | | |
| Control 3 | Could not evaluate due to strong | | | — |
| | paper adherence to meat surface | | | |
| Sample 1 | 27.3 ± 2.6 | 12.2 ± 1.2 | 9.1 ± 1.6 | 3 |
| Sample 2 | 29.9 ± 3.9 | 13.2 ± 1.2 | 11.1 ± 2.3 | 2.5 |

Netting impression score: 0 (no impression), 5 (strong impressions)
L-Values describe degree of darkness; L-Value of 100 = white, 0 = black.
a-Values describe degree of redness; redness increases with increasing a-Values
b-Values describes degrees of yellowness; yellowness increases with increasing b-Values.

Table 7 illustrates that the liquid smoke color successfully transferred to the meat product from the test papers. The test samples 1 and 2 have L, a, and b values that show that liquid smoke color was transferred from the treated sample papers to the enveloped hams. Controls 2 and 3 were impossible to evaluate because even though the hams wrapped in these papers were oversmoked with liquid smoke, the lack of a peeling aid on a lower fat content meat product precluded the removal of the paper from the processed ham.

We claim:

1. An article for imparting color and flavor to a food product processed or packaged in said article, said article comprising:
a) a porous, permeable, absorbent substrate formed of paper or cellophane having sufficient suppleness and elasticity to be wrapped around the food product;
b) liquid smoke contained by said substrate in an amount of at least about 10% based on the weight of said substrate;
c) a peeling aid applied to a food product-contacting surface of said substrate;
d) said substrate having sufficient permeability to allow for the transfer of smoke color and flavor to the food product during the processing of the food product in said article; and
e) said substrate with said liquid smoke and said peeling aid having sufficient wet strength, cohesion and peelability to permit the removal of said substrate from the food product after the processing of the food product in said article without leaving a substrate residue on the food product.

2. An article as in claim 1, wherein said substrate is a paper having a basis weight of at least about 12.3 grams/m² and an MD wet strength of at least 970 grams/25 mm stretch.

3. An article as in claim 1, wherein said substrate is cellophane having a basis weight of at least about 29 grams/m², a MD dry strength of at least 125 MN/m² stretch and a CD dry strength of at least 70 MN/m² stretch.

4. An article as in claim 1, wherein said substrate is paper and a side of said substrate not in contact with the food product is provided with a moisture vapor or oxygen impermeable coating or film.

5. An article as in claim 4, wherein said film is selected from the group consisting of polyvinylidene chloride, polyvinylchloride, polyvinylacetate, polyvinylalcohol, polyethylene, and wax.

6. An article as in claim 1, additionally comprising a caramel contained by said substrate.

7. An article as in claim 6, wherein said substrate contains caramel and liquid smoke in a ratio of caramel to liquid smoke of from about 1:20 to about 20:1.

8. An article as in claim 1, additionally including a coloring agent selected from the group consisting of natural coloring agents and FD&C food grade coloring agents.

9. An article as in claim 1, including a flavoring agent on said substrate.

10. An article as in claim 9, wherein said flavoring agent is selected from the group consisting of oleo resins and seasonings including paprika, pepper, garlic and onion.

11. An article as in claim 1, wherein said peeling aid is lecithin or lecithin in an edible hydrocarbon diluent.

12. An article as in claim 1, wherein said peeling aid is a combination of lecithin and a compound selected from the group consisting of alginates, alginic acid, chitosan, casein, wax, shortening, vegetable oil, cellulose ether, carboxymethyl cellulose, methyl cellulose, hydroxy propylcellulose, ethyl methyl cellulose, hydroxyethyl cellulose, ethyl hydroxy ethyl cellulose and mixtures thereof.

13. An article as in claim 1, wherein the peeling aid is alkylketene dimer.

14. An article as in claim 1, wherein the pH of said liquid smoke is in the range of from about 2 to about 14.

15. A process for adding liquid smoke color and flavor to processed food products comprising:
a) providing a sheet having sufficient suppleness and elasticity to be wrapped around the food product, the sheet comprising a porous, absorbent substrate of paper or cellophane having a food-contacting side treated with a peeling aid and liquid smoke at a pH from about 2 to about 14 in an amount from at least about 10% based on the weight of the untreated substrate covering the food product;
b) covering the food product with the sheet such that said treated side is against the surface of the food product;
c) processing the food product under conditions permitting the transfer of smoke color and flavor to the surface of the food product; and
d) removing the sheet from the food product, said substrate having sufficient retained wet strength so said removing is accomplished without leaving a residue of said substrate on the food product.

16. A process as in claim 15, wherein said substrate is paper having a basis weight of at least about 12.3 grams/m² and an MD wet strength of at least 970 grams/25 mm stretch.

17. An process as in claim 15, wherein said substrate is cellophane having a basis weight of at least about 29 grams/m², an MD dry strength of at least 125 MN/m² stretch and a CD dry strength of at least 70 MN/m² stretch.

18. A process as in claim 15, comprising first covering the food product with said sheet and then covering the wrapped food product with netting.

19. A process as in claim 15, wherein the food product is meat, cheese or beans.

20. A process as in claim 19, wherein said meat is ham, chicken, chicken parts, turkey, beef or pork.

21. A process as in claim 15, wherein said peeling aid is lecithin or lecithin in an edible hydrocarbon diluent.

22. A process as in claim 21, wherein said peeling aid is a combination of lecithin and a compound selected from the group consisting of alginates, alginic acid, chitosan, casein, wax, shortening, vegetable oil, cellulose ether, carboxymethyl cellulose, methyl cellulose, hydroxy propylcellulose, ethyl methyl cellulose, hydroxyethyl cellulose, ethyl hydroxy ethyl cellulose and mixtures thereof.

23. A process for the manufacture of an article for imparting smoke flavor and color to a food product, said process comprising:
a) providing a porous permeable substrate in the form of a sheet composed of paper or cellophane;
b) treating the substrate in a bath containing an emulsion of liquid smoke and a peeling aid;
c) recovering from the bath treated substrate having absorbed under controlled conditions at least about 10% of the liquid smoke based on the weight of the untreated substrate.

24. A process as in claim 23, wherein said substrate is paper having a basis weight of at least 12.3 grams/m² and a machine direction wet strength of at least 970 grams per 25 mm stretch.

25. An process as in claim 15, wherein said substrate is cellophane having a basis weight of at least about 29 grams/m², an MD dry strength of at least 125 MN/m² stretch and a CD dry strength of at least 70 MN/m² stretch.

26. An article for thermally processing a food product, said article comprising:
a) a porous, permeable, absorbent substrate formed of paper or cellophane having sufficient suppleness and elasticity to be wrapped around the food product;
b) a peeling aid applied to a food product-contacting surface of said substrate; and
c) said substrate containing said peeling aid having sufficient wet strength, cohesion and peelability to permit the removal of said substrate from the food product after the processing of the food product in said article without leaving a substrate residue on the food product.

27. An article as in claim 26, wherein said substrate is paper and a side of said substrate not in contact with the food product is provided with a moisture vapor or oxygen impermeable coating or film.
